(19) United States
(12) Patent Application Publication
(10) Pub. No.: US 2026/0360077 A1
(43) Pub. Date: Nov. 12, 2026

(54) REAL-TIME DETECTION OF ABUSE USING A MULTI-MODAL MACHINE-LEARNING MODEL

(71) Applicant: Roblox Corporation, San Mateo, CA (US)

(72) Inventors: Younes ABOUELNAGAH, San Mateo, CA (US); Chi Ming WONG, San Mateo, CA (US)

(73) Assignee: Roblox Corporation, San Mateo, CA (US)

(21) Appl. No.: 19/202,561

(22) Filed: May 8, 2025

(51) Int. Cl. G06T 17/00; G06V 10/74; G06V 10/764

(52) U.S. Cl. CPC G06T 17/00; G06V 10/761; G06V 10/764

(57) ABSTRACT

A moderation application identifies a plurality of periodic observations that describe user activity associated with a user account of a user of a virtual environment platform. A machine-learning model outputs vector representations of respective periodic observations that encode the periodic observations in embedding space. The moderation application compares the vector representations of the respective periodic observations to entries stored in database of abusive behavior embeddings and in a database of benign behavior embeddings. The moderation application generates a similarity score for each of the vector representations based on a similarity of a respective vector representation to at least one abusive behavior embedding and a similarity of the respective vector representation at least one benign behavior embedding. The moderation application generates a risk score for the user account. In response to determining that the risk score meets a first threshold value, the moderation application performs a remedial action.

### TECHNICAL FIELD

Embodiments relate generally to detecting abuse in a virtual environment, and more particularly, to methods, systems, and computer readable media for identifying abuse using a multi-modal embedding modal, aggregation, and risk scoring.

### BACKGROUND

Abuse in a virtual environment occurs in multiple ways. For example, avatars may wear offensive outfits, players may perform offensive actions, players may say offensive (abusive) things in audio chat, and/or players may type offensive words into a group chat. An online platform moderates user-generated content to ensure compliance with content moderation policies and protect users from harmful behavior.

Traditional content moderation approaches often rely on manual review or rule-based systems that struggle to keep pace with the evolving tactics of malicious actors and the scale of user-generated content. These methods are often slow, expensive, and prone to errors, especially when dealing with nuanced or ambiguous content. For example, a user threatening violence may be saying contextually appropriate things if the game is a shooter game, while the same words may be inappropriate in a different game setting.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method comprises identifying a plurality of periodic observations that describe user activity associated with a user account of a user of a virtual environment platform, wherein each periodic observation is associated with timestamps that are within a bounded time period. The method further includes providing the periodic observations as input to a machine-learning model. The method further includes outputting, with the machine-learning model, vector representations of respective periodic observations that encode the periodic observations in embedding space, wherein a distance in the embedding space between two vector representations is indicative of similarity of user behaviors in the corresponding periodic observations. The method further includes comparing the vector representations of the respective periodic observations to entries stored in database of abusive behavior embeddings and in a database of benign behavior embeddings, wherein the entries are in the embedding space. The method further includes generating a similarity score for each of the vector representations based on a similarity of a respective vector representation to at least one abusive behavior embedding and a similarity of the respective vector representation to at least one benign behavior embedding. The method further includes generating a risk score for the user account based on aggregating similarity scores. The method further includes responsive to determining that the risk score meets a first threshold value, performing a remedial action on the user account.

In some embodiments, the machine-learning model is a multimodal machine-learning model and the periodic observations that describe the user activity include one or more of: text from the user account, audio from the user account, one or more images of an avatar associated with the user account, one or more images associated with the user account, and any combination thereof. In some embodiments, generating the similarity score based on the similarity of the respective vector representation to the at least one abusive behavior embedding and the at least one benign behavior embedding includes classifying the respective vector representation using a k-nearest neighbors algorithm. In some embodiments, the similarity score is generated based on contrastive learning by: calculating a first exponent of an aggregation of the similarity of the respective vector representation to a predetermined number of abusive behavior embeddings; calculating a second exponent of an aggregation of the similarity of the respective vector representation to a predetermined number of benign behavior embeddings; and dividing the first exponent by the second exponent or dividing the first exponent by a sum of the first exponent and the second exponent.

In some embodiments, responsive to the risk score meeting a second threshold value, providing a request to a moderator to review a portion of the user activity, wherein the second threshold value is lower than the first threshold value; and responsive to the moderator reviewing the portion of the user activity, providing feedback from the moderator to a user history associated with the user account, wherein the risk score is further based on the user history. In some embodiments, providing the request to the moderator to review the portion of the user activity includes adding the request to a queue for the moderator to review; and the queue is sorted based on the risk score. In some embodiments, responsive to the risk score meeting the first threshold, the remedial action is selected from a group of providing a warning to the user; preventing the user from submitting at least one of text, audio, and images on the virtual environment platform; suspending the user account for a predetermined period of time; banning the user account, or combinations thereof. In some embodiments, the abusive behavior embeddings correspond to abusive behavior that are identified as abusive by one or more moderators and the benign behavior embeddings correspond to benign behavior that are identified by excluding abusive behavior from a corpus of prior user activity. In some embodiments, the risk score is based on a skewness of the similarity scores to reduce an effect of a number of the similarity scores in a distribution. In some embodiments, the method further includes calculating the skewness by determining a difference between a mean of the similarity scores from a median of the similarity scores and dividing the difference by a standard deviation of the similarity scores.

A system includes one or more processors; and a memory coupled to the one or more processors, with instructions stored thereon that, when executed by the processor, cause the processor to perform operations. The operations include: identifying a plurality of periodic observations that describe user activity associated with a user account of a user of a virtual environment platform, wherein each periodic observation is associated with timestamps that are within a bounded time period; providing the periodic observations as input to a machine-learning model; outputting, with the machine-learning model, vector representations of respective periodic observations that encode the periodic observations in embedding space, wherein a distance in the embedding space between two vector representations is indicative of similarity of user behaviors in the corresponding periodic observations; comparing the vector representations of the respective periodic observations to entries stored in database of abusive behavior embeddings and in a database of benign behavior embeddings, wherein the entries are in the embedding space; generating a similarity score for each of the vector representations based on a similarity of a respective vector representation to at least one abusive behavior embedding and a similarity of the respective vector representation to at least one benign behavior embedding; generating a risk score for the user account based on aggregating similarity scores; and responsive to determining that the risk score meets a first threshold value, performing a remedial action on the user account.

In some embodiments, the machine-learning model is a multimodal machine-learning model and the periodic observations that describe the user activity include one or more of: text from the user account, audio from the user account, one or more images of an avatar associated with the user account, one or more images associated with the user account, and any combination thereof. In some embodiments, generating the similarity score based on the similarity of the respective vector representation to the at least one abusive behavior embedding and the at least one benign behavior embedding includes classifying the respective vector representation using a k-nearest neighbors algorithm. In some embodiments, the similarity score is generated based on contrastive learning by: calculating a first exponent of an aggregation of the similarity of the respective vector representation to a predetermined number of abusive behavior embeddings; calculating a second exponent of an aggregation of the similarity of the respective vector representation to a predetermined number of benign behavior embeddings; and dividing the first exponent by the second exponent or dividing the first exponent by a sum of the first exponent and the second exponent. In some embodiments, the operations further include responsive to the risk score meeting a second threshold value, providing a request to a moderator to review a portion of the user activity, wherein the second threshold value is lower than the first threshold value; and responsive to the moderator reviewing the portion of the user activity, providing feedback from the moderator to a user history associated with the user account, wherein the risk score is further based on the user history.

A non-transitory computer-readable medium with instructions stored thereon that, when executed by one or more computers, cause the one or more computers to perform operations. The operations include: The operations include: identifying a plurality of periodic observations that describe user activity associated with a user account of a user of a virtual environment platform, wherein each periodic observation is associated with timestamps that are within a bounded time period; providing the periodic observations as input to a machine-learning model; outputting, with the machine-learning model, vector representations of respective periodic observations that encode the periodic observations in embedding space, wherein a distance in the embedding space between two vector representations is indicative of similarity of user behaviors in the corresponding periodic observations; comparing the vector representations of the respective periodic observations to entries stored in database of abusive behavior embeddings and in a database of benign behavior embeddings, wherein the entries are in the embedding space; generating a similarity score for each of the vector representations based on a similarity of a respective vector representation to at least one abusive behavior embedding and a similarity of the respective vector representation to at least one benign behavior embedding; generating a risk score for the user account based on aggregating similarity scores; and responsive to determining that the risk score meets a first threshold value, performing a remedial action on the user account.

In some embodiments, the machine-learning model is a multimodal machine-learning model and the periodic observations that describe the user activity include one or more of: text from the user account, audio from the user account, one or more images of an avatar associated with the user account, one or more images associated with the user account, and any combination thereof. In some embodiments, generating the similarity score based on the similarity of the respective vector representation to the at least one abusive behavior embedding and the at least one benign behavior embedding includes classifying the respective vector representation using a k-nearest neighbors algorithm. In some embodiments, the similarity score is generated based on contrastive learning by: calculating a first exponent of an aggregation of the similarity of the respective vector representation to a predetermined number of abusive behavior embeddings; calculating a second exponent of an aggregation of the similarity of the respective vector representation to a predetermined number of benign behavior embeddings; and dividing the first exponent by the second exponent or dividing the first exponent by a sum of the first exponent and the second exponent. In some embodiments, the operations further include responsive to the risk score meeting a second threshold value, providing a request to a moderator to review a portion of the user activity, wherein the second threshold value is lower than the first threshold value; and responsive to the moderator reviewing the portion of the user activity, providing feedback from the moderator to a user history associated with the user account, wherein the risk score is further based on the user history.

### BRIEF DESCRIPTION OF THE DRAWINGS

FIG. 1 is a block diagram of an example network environment, according to some embodiments described herein.

FIG. 2 is a block diagram of an example computing device, according to some embodiments described herein.

FIG. 3 is a block diagram of an example architecture of the moderation application, according to some embodiments described herein.

FIG. 4 is a block diagram of an additional example architecture of the moderation application, according to some embodiments described herein.

FIG. 5 is an example of similarity scores for text chat, according to some embodiments described herein.

FIG. 6 illustrates an example user interface of a remedial action, according to some embodiments described herein.

FIG. 7 is a flowchart of an example method to moderate user activity, according to some embodiments described herein.

### DETAILED DESCRIPTION

### Overview

Existing content moderation systems for virtual environment platforms often focus on identifying individual instances of harmful content, rather than assessing the overall risk posed by a user. For example, a user may make an inappropriate solicitation for a user's personal information that is an attempt to be friendly, rather an instance of identity theft. Immediately banning that user harms the user experience.

The disclosure advantageously describes a moderation application that monitors user behavior in real-time across multiple modalities, extracts relevant features, and aggregates the observations into a risk score that adapts to evolving user behavior. The user behavior may include text (e.g., text chats between users), audio (e.g., audio chat between users), and images (e.g., an image of an avatar created by a user, an image of a virtual experience created by a user, an image shared in a text chat, etc.). The moderation application identifies periodic observations from the user activity. For example, each periodic observation may represent 1 minute (or 30 seconds, 40 seconds, 1.5 minutes, etc.) of user activity.

A machine-learning model generates a vector representation for each periodic observation. The moderation application compares each vector representation to entries in a database of abusive behavior embeddings and a database of benign behavior embeddings and uses the comparison to generate a similarity score for each vector representation. In some embodiments, the comparison includes identifying the difference between the vector representation and a number of nearest abusive behavior embeddings and the difference between the vector representation and a number of nearest benign behavior embeddings using a k-nearest neighbor algorithm. The differences are used to calculate a similarity score based on contrastive learning.

Each similarity score represents a discrete risk of abuse. Take for example, a case where a user is engaging in the harmful behavior of trying to cause other users to disclose personally identifiable information. A first similarity score reflects the user's attempt to identify another user based on a name (“Hey, what's your name?”). A second similarity score reflects the user's attempt to identify another user based on age (“Hey, what's your age?”). These represent low-level harmful behavior that, while not actionable on their own, may indicate a higher risk of future violations.

The moderations application aggregates the similarity scores and other relevant features over time to periodically generate a user-specific risk score. The other relevant features may include previous violations. The aggregation process may be based on a skewness of the similarity scores that prevents more active users from being more harshly scored than less active users based on having more instances of user activity.

The moderation application performs a remedial action based on the risk score value. For example, continuing with the example above, if the user makes a more aggressive attempt to identify another user (“Do you live at 1 Main St. in Sudbery, M assachusetts? I live nearby, can I come over this afternoon?”), the risk score may meet a first threshold that results in an automatic ban, a temporary suspension, or another serious remedial action. If the user makes a less aggressive attempt to identify the other user (“Are you the Sarah Jones that lives in Sudbery, Massachusetts? I think I went to school with your sister.”), the risk score may meet a second threshold that results in a request for a moderator to review the user activity and assess whether this behavior is an attempt to be friendly or a more suspicious attempt to identify the user for possibly nefarious purposes. The moderator may review the user activity and modify the risk score to be higher, resulting in the risk score meeting the first threshold. The moderator may impose a lesser remedial action, such as providing the user with a warning and a reminder to adhere to community guidelines.

Unlike other content moderation systems, the moderation application does not immediately ban users, which could result in banning users that were trying to be friendly and were not engaging in abusive behavior, thereby resulting in a diminished user experience. Instead, the moderation application advantageously maintains the safety of the users by preventing escalation of abusive behaviors while accurately assessing the risk presented by user actions.

### Network Environment

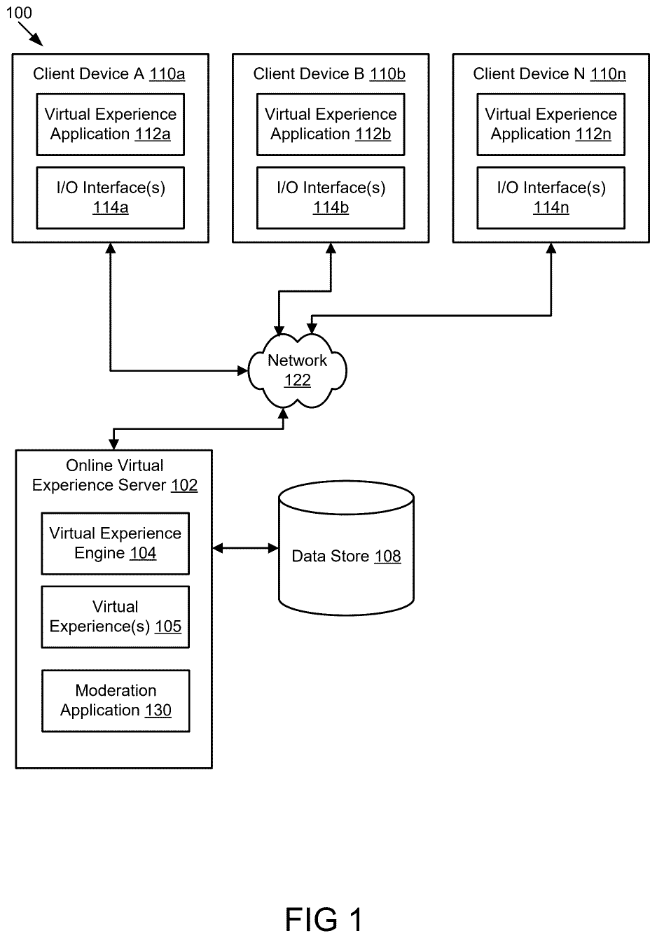

FIG. 1 illustrates an example network environment 100, in accordance with some embodiments of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, and a client device 110 (or multiple client devices), all connected via a network 122.

The online virtual experience server 102 can include, among other things, a virtual experience engine 104, one or more virtual experiences 105, and a moderation application 130. The online virtual experience server 102 may be configured to provide virtual experiences 105 to one or more client devices 110, and to moderate user activity via the moderation application 130, in some embodiments.

Data store 108 is shown coupled to online virtual experience server 102 but in some embodiments, can also be provided as part of the online virtual experience server 102. The data store may, in some embodiments, be configured to store advertising data, user data, engagement data, embeddings, libraries, and/or other contextual data in association with the moderation application 130.

The client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some embodiments, the client devices 110 may be configured to execute and display virtual experiences, which may include virtual user engagement portals as described herein.

Network environment 100 is provided for illustration. In some embodiments, the network environment 100 may include the same, fewer, more, or different elements configured in the same or different manner as that shown in FIG. 1.

In some embodiments, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some embodiments, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some embodiments, the online virtual experience server 102 can include a server having one or more computing devices (e.g., a cloud computing system, a rackmount server, a server computer, cluster of physical servers, virtual server, etc.). In some embodiments, a server may be included in the online virtual experience server 102, be an independent system, or be part of another system or platform. In some embodiments, the online virtual experience server 102 may be a single server, or any combination a plurality of servers, load balancers, network devices, and other components. The online virtual experience server 102 may also be implemented on physical servers, but may utilize virtualization technology, in some embodiments. Other variations of the online virtual experience server 102 are also applicable.

In some embodiments, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., user 114 via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some embodiments, online virtual experience server 102 may include digital asset and digital virtual experience generation provisions. For example, the platform may provide administrator interfaces allowing the design, modification, unique tailoring for individuals, and other modification functions. In some embodiments, virtual experiences may include two-dimensional (2D) games, three-dimensional (3D) games, virtual reality (VR) games, or augmented reality (AR) games, for example. In some embodiments, virtual experience creators and/or developers may search for virtual experiences, combine portions of virtual experiences, tailor virtual experiences for particular activities (e.g., group virtual experiences), and other features provided through the virtual experience server 102.

In some embodiments, online virtual experience server 102 or client device 110 may include the virtual experience engine 104 or virtual experience application 112. In some embodiments, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some embodiments, each virtual experience 105 may have a different ratio between the virtual experience engine functions that are performed on the online virtual experience server 102 and the virtual experience engine functions that are performed on the client device 110.

In some embodiments, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some embodiments, the client device(s) 110 may each include computing devices such as personal computers (PCs), mobile devices (e.g., laptops, mobile phones, smart phones, tablet computers, or netbook computers), network-connected televisions, gaming consoles, etc. In some embodiments, a client device 110 may also be referred to as a “client device 110.” In some embodiments, one or more client devices 110 may connect to the online virtual experience server 102 at any given moment. It may be noted that the number of client devices 110 is provided as illustration, rather than limitation. In some embodiments, any number of client devices 110 may be used.

In some embodiments, each client device 110 may include an instance of the virtual experience application 112. The virtual experience application 112 may be rendered for interaction at the client device 110. During user interaction within a virtual experience 105 or another GU I of the online platform 100, a user may create an avatar that includes different body parts and clothing from different libraries. The user participates in a virtual experience 105 via the avatar.

The moderation application 130 identifies user activities associated with a user account in a virtual environment platform. For example, the user activity may include creation of the avatar, interaction with other avatars in each virtual experience 105, actions performed in the virtual experience 105, text provided in a group chat, audio provided in audio chat, etc. The moderation application 130 identifies periodic observations that describe the user activity within a bounded time period. For example, each user activity may be 30 seconds (or 1 minute, or 10 seconds, etc.).

The moderation application 130 generates vector representations of respective periodic observations. The moderation application 130 provides the vector representations as input to a machine-learning model that includes embeddings in embedding space. The machine-learning model outputs similarity scores that reflect a similarity of a vector representation of the user activity to abusive behavior embeddings and benign behavior embeddings.

The moderation application 130 generates a risk score based on aggregating the similarity scores and user history. If the risk score meets a threshold value, the moderation application 130 performs a remedial action on the user account, such as warning the user, temporarily suspending the user account, flagging the user account for manual review, monitoring the user account, or banning the user account.

### Computing Device

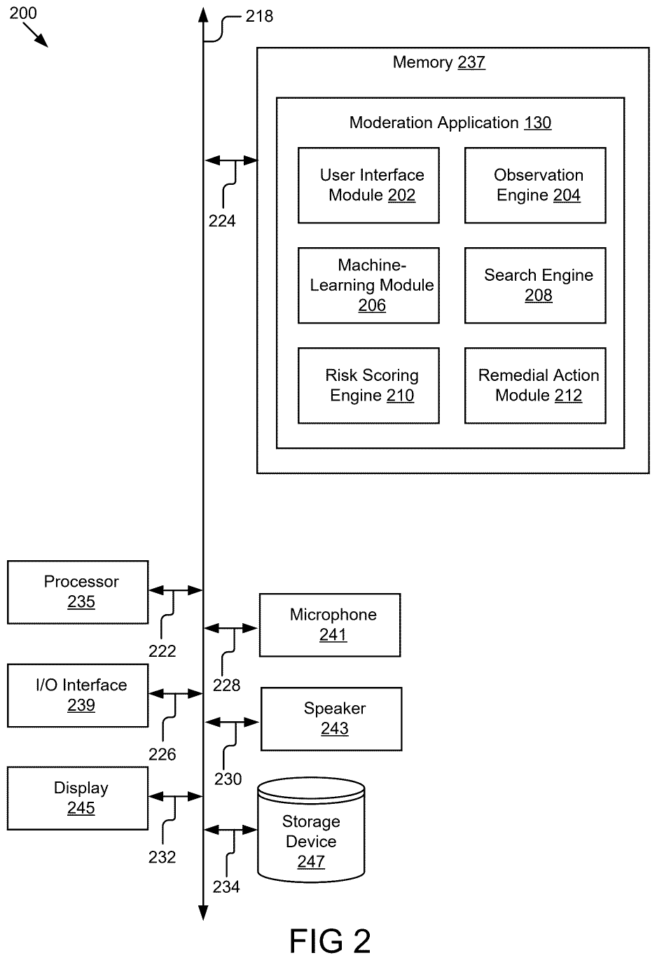

FIG. 2 is a block diagram of an example computing device 200 that may be used to implement one or more features described herein. Computing device 200 can be any suitable computer system, server, or other electronic or hardware device. In some embodiments, the computing device 200 is the client device 110. In some embodiments, the computing device 200 is the online virtual experience server 102.

In some embodiments, computing device 200 includes a processor 235, a memory 237, an Input/Output (I/O) interface 239, a microphone 241, a speaker 243, a display 245, and a storage device 247, all coupled via a bus 218. In some embodiments, the computing device 200 includes additional components not illustrated in FIG. 2. In some embodiments, the computing device 200 includes fewer components than are illustrated in FIG. 2. For example, in instances where the moderation application 130 is stored on the online virtual experience server 102 in FIG. 1, the computing device may not include a microphone 241, a speaker 243, or a display 245.

The processor 235 may be coupled to a bus 218 via signal line 222, the memory 237 may be coupled to the bus 218 via signal line 224, the I/O interface 239 may be coupled to the bus 218 via signal line 226, the microphone 241 may be coupled to the bus 218 via signal line 228, the speaker 243 may be coupled to the bus 218 via signal line 230, the display 245 may be coupled to the bus 218 via signal line 232, and the storage device 247 may be coupled to the bus 218 via signal line 234.

The processor 235 includes an arithmetic logic unit, a microprocessor, a general-purpose controller, or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. In some embodiments, the processor 235 may include special-purpose units, e.g., machine learning processor, audio/video encoding and decoding processor, etc. Although FIG. 2 illustrates a single processor 235, multiple processors 235 may be included. In different embodiments, processor 235 may be a single-core processor or a multicore processor. Other processors (e.g., graphics processing units), operating systems, sensors, displays, and/or physical configurations may be part of the computing device 200, such as a keyboard, mouse, etc.

The memory 237 stores instructions that may be executed by the processor 235 and/or data. The instructions may include code and/or routines for performing the techniques described herein. The memory 237 may be a dynamic random access memory (DRAM) device, a static RAM, or some other memory device. In some embodiments, the memory 237 also includes a non-volatile memory, such as a static random access memory (SRA M) device or flash memory, or similar permanent storage device and media including a hard disk drive, a compact disc read only memory (CD ROM) device, a DVD ROM device, a DVD RAM device, a DVD RW device, a flash memory device, or some other mass storage device for storing information on a more permanent basis. The memory 237 includes code and routines operable to execute the moderation application 130, which is described in greater detail below.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 247), and input/output devices can communicate via I/O interface 239. In another example, the I/O interface 239 can receive data from the online virtual experience server 102 and deliver the data to the moderation application 130 and components of the moderation application 130, such as the user interface module 202. In some embodiments, the I/O interface 239 can connect to interface devices such as input devices (keyboard, pointing device, touchscreen, microphone 241, sensors, etc.) and/or output devices (display 245, speaker 243, etc.).

Some examples of interfaced devices that can connect to I/O interface 239 can include a display 245 that can be used to display content, e.g., images, video, and/or a user interface of the metaverse as described herein, and to receive touch (or gesture) input from a user. Display 245 can include any suitable display device such as a liquid crystal display (LCD), light emitting diode (LED), or plasma display screen, cathode ray tube (CRT), television, monitor, touchscreen, three-dimensional display screen, a projector (e.g., a 3D projector), or other visual display device.

The microphone 241 includes hardware, e.g., one or more microphones that detect audio spoken by a person. The microphone 241 may transmit the audio to the moderation application 130 via the I/O interface 239.

The speaker 243 includes hardware for generating audio for playback. In some embodiments, the speaker 243 may include audio hardware that supports playback via an external, separate speaker (e.g., wired or wireless headphones, external speakers, or other audio playback device) that is coupled to the computing device 200.

The storage device 247 stores data related to the moderation application 130. For example, the storage device 247 may store a user profile associated with a user 125, libraries, embeddings, vector databases, abuse reports, etc.

### Moderation Application

FIG. 2 illustrates a computing device 200 that executes an example moderation application 130 that includes a user interface module 202, an observation engine 204, a machine-learning module 206, a search engine 208, a risk scoring engine 210, and a remedial action module 212. In some embodiments, a single computing device 200 includes all the components illustrated in FIG. 2. In some embodiments, one or more of the components may be on different computing devices 200. For example, the client device 110 may include the user interface module 202 and the remedial action module 212, while the observation engine 204, the machine-learning module 206, search engine 208, risk scoring engine 210, and the remedial action module 212 are implemented on the online virtual experience server 102. In some embodiments, different portions of one or more of modules/engines 202, 204, 206, 208, 210, and 212 may be implemented on the client device 110 or on the online virtual experience server 102.

The user interface module 202 generates graphical data for displaying a user interface for users associated with client devices 110 to participate in a virtual experience. In some embodiments, before a user participates in the virtual experience, the user interface module 202 generates a user interface that includes information about how the user's information may be collected, stored, and/or analyzed. For example, the user interface requires the user to provide permission to use any information associated with the user and accept terms and conditions. If the user does not accept the terms and conditions, the user is excluded from the virtual environment platform.

The user may have the option to choose what types of information are provided for different uses. For example, the user may permit collection and use of data for moderation as part of the terms and conditions of the virtual environment platform. In some embodiments, the data is stored and analyzed via an automatic process and only in cases where abusive behavior is identified for manual review. The manual review is performed in a confidential manner, the user identity and personally identifiable information are masked, and the moderation team is subject to legal and business training and contractual norms related to user privacy. The collection and use of the information is in accordance with applicable regulations and users do not have an ability to opt out. Data collection is not performed in certain locations and for certain user categories, the data collection is temporary (i.e., the data is discarded after a period of time), and the data is not shared with third parties. Some of the data may be anonymized, aggregated across users, or otherwise modified so that specific user identity cannot be determined. The collected data is stored securely.

In some embodiments, the user interface module 202 generates a user interface for accepting user input that includes creating an avatar. For example, the user interface may include options for creating a human, humanoid, or non-human avatar. Each instance of user input is an example of user activity. The user interface module 202 generates a user interface for configuring an appearance of the avatar. For example, the avatar may include different hairstyles, clothing, accessories, etc.

The user activities for creating the avatar may include instances of content violations, such as an avatar with enlarged genitals; inappropriate secondary sex characteristics; profanity, obscene gestures, and/or obscene depictions of actions on clothing worn by the avatar, etc. The user interface module 202 provides user input related to creating the avatar and/or configuring the appearance of the avatar to the observation engine 204.

The user interface module 202 receives user activities from a user during gameplay of a virtual experience. For example, the user activities may include information to cause an avatar to move around, perform actions, change poses, speak to other users (via text chat or audio chat), etc. in the virtual experience. The user interface module 202 generates graphical data for displaying the location, actions, poses, etc. of the avatar within the virtual experience.

The user may interact with other users in the virtual experience. Some of these interactions may be negative and, in some embodiments, the user interface module 202 generates graphical data for a user interface that enables a user to limit exposure to other users that the user wants to avoid. For example, the user interface module 202 may include an option to mute other users, block other users, and to report abuse that occurs in the virtual experience. For example, another avatar may be wearing an objectionable piece of clothing, an avatar may be holding an inappropriate object (e.g., a flag associated with a hate group, an object in the shape of something offensive, etc.), an avatar may perform an offensive action (e.g., the avatar may use spray paint to draw an image of genitals, show a middle finger, move in a way that is suggestive, etc.), an avatar may utter an inappropriate statement (e.g., either in a text chat or directly via audio chat to the user), or an avatar may make an inappropriate noise (e.g., grunting, simulation of sexual noises, etc.). One avatar may also be associated with multiple types of abusive behavior, such as wearing inappropriate clothing while performing an offensive act.

The user interface module 202 generates a user interface for a user to communicate with other users via text chat and/or audio chat. Users may communicate with each other using the user interface. For example, users may use text chat and/or audio chat to comment on a virtual experience, but the text and/or audio may switch to other types of conversations that include abusive behavior.

As is described in greater detail below, the remedial action module 212 determines that a user committed abuse and performs a remedial act in response to determining that the user committed abuse. In some embodiments, the remedial act includes providing a warning to the user. The remedial action module 212 may instruct the user interface module 202 to generate graphical data for displaying a warning. In some embodiments, the remedial act includes muting a microphone on the client device associated with the user. In some embodiments, instead of muting the microphone on the client device, the remedial action module 212 suppresses the user-provided audio stream from being delivered to one or more other users. In this situation the remedial action module 212 instructs the user interface module 202 to generate graphical data to explain to the user that their microphone has been muted, how long the microphone is muted for, how additional violations will result in more extreme consequences, etc. In some embodiments, the remedial action module 212 temporarily suspends the user account. In this situation the remedial action module 212 instructs the user interface module 202 to generate graphical data to explain to the user that the virtual environment is inaccessible for a predetermined period of time, how additional violations will result in a ban, etc. In some embodiments, remedial action module 212 bans the user account. In this case the remedial action module 212 instructs the user interface module 202 to explain the conditions of a permanent ban.

The observation engine 204 identifies periodic observations that describe user activity associated with a user account in a virtual environment platform for an active user. Each periodic observation is identified by timestamps that are within a bounded time period. For example, a periodic observation may be a sliding window of user activities that occur over a period of time (e.g., 20 seconds, 30 seconds, 40 seconds, one minute, etc.). In some embodiments, the window is a tumbling window that divides the user activity into fixed-size, non-overlapping time intervals. In some embodiments, the window is a sliding window that divides the user activity into fixed size, overlapping time intervals). For example, each periodic observation may include 60 seconds of user activity that are identified every 30 seconds, resulting in 30 seconds of overlap. In some embodiments, the observation engine 204 receives user activity in overlapping time intervals and converts the user activity into non-overlapping time intervals.

The user activity includes any actions associated with a user. For example, the user activity may include text from the user (e.g., text provided to a group chat, text used in a blurb, etc.), audio from the user (e.g., audio provided to an audio group), images of an avatar designed by the user, and images associated the user (e.g., image of an asset, image of the user's avatar, uploaded GIFs, images from a camera roll on a user device, etc.), videos uploaded by the user (e.g., videos of the user's avatar with other user avatars, etc.), actions performed by the user within the virtual experience (e.g., gestures), etc.

In some embodiments, a user that is part of a first experience may perform user activity that includes using text chat and/or audio chat to communicate with another user in the first experience or in a second experience. For example, a first user may use a calling feature implemented by the virtual experience engine 104 to call a second user to communicate via audio chat. The observation engine 204 provides periodic observations that describe user activity to the machine-learning module 206.

The machine-learning module 206 includes a trained machine-learning model that is trained to generate embeddings from the periodic observations that describe user activity in a virtual environment. In some embodiments, the machine-learning model may be a multimodal model that can generate embeddings from text, audio, video, images, avatar motion, or other user activity representations in a virtual environment. The embeddings are in an embedding space. In some embodiments, the embedding space may be such that embeddings correspond to different types of abusive behaviors and levels of abusiveness are relatively well-separated from each other, while embeddings that correspond to benign user activity are relatively closer together but are separated from all embeddings corresponding to abusive behavior.

In some embodiments, the machine-learning module 206 receives a pre-trained model that was pre-trained on a large unlabeled dataset. The machine-learning module 206 may perform fine-tuning of the pre-trained machine-learning model on user activity associated with a virtual environment. In some embodiments, the machine-learning module 206 performs fine-tuning with a labelled dataset that is smaller than the unlabeled dataset used during pre-training.

In some embodiments, examples of abusive behavior are identified from user activities by moderators. For example, moderators may review user activity associated with abuse reports and/or requests to review a portion of user activity and identify the user activity as abusive or benign. In some embodiments, examples of benign behavior are identified by filtering abusive behavior from user activity and taking random samples of the remaining user activity.

In some embodiments, the machine-learning module 206 trains or fine-tunes the machine-learning model with user activity associated with multiple users. The user activity is obtained responsive to obtaining user consent from users that are legally and regulation-wise qualified to grant permission (e.g., a parent for a user below certain ages, the user themselves for certain ages, etc.). User-identifiable information is removed from the user activity. The user activity is collected using security communications that are not stored once training or fine tuning of the machine-learning model is complete. For example, the user activity may be removed once the embeddings are generated. All applicable laws and regulations are followed regarding user-provided audio.

In some embodiments, the machine-learning model is a multimodal machine-learning model that generates vector representations of different types of user activities. In some embodiments, the machine-learning model includes a plurality of machine-learning models for each type of user activity or a single machine-learning model that embeds different types of user activities. The multimodal machine-learning model may include text embeddings, audio embeddings, and image embeddings. In some embodiments, the machine-learning model includes an English machine-learning model and a language-agnostic machine-learning model. In some embodiments, the machine-learning model includes a variety of different language models (e.g., French, Spanish, Hindi, etc.).

In some embodiments, the machine-learning model includes tabular features, such as user information or statistics. The user information is used to provide historical context that complements the vector representations generated by the machine-learning model. For example, historical data, such as prior moderation outcomes or counts of specific flagged behaviors over time, can be used to calculate a longer-term risk assessment or affinity score for certain types of harmful behavior. This score can augment the risk signals derived from immediate activity. Features derived from this tabular data (e.g., counts of past reports, types of prior violations, historical risk scores, account age, verification status) are also used as input by the risk scoring engine 210 to help differentiate between isolated incidents and sustained problematic behavior patterns, and can inform the remedial actions taken.

The machine-learning model may perform processing of the user activity before the machine-learning model outputs an embedding. For example, the machine-learning model may convert the audio into text and then output a vector representation of the text. In another example, the machine-learning model may convert the audio into tokens and then output a vector representation from the tokens. In some embodiments, the machine-learning model performs tokenization of user activity to obtain token-level embeddings and mean pooling to convert the token-level embeddings into a vector representation.

The machine-learning module 206 receives periodic observations from the observation engine 204. In some embodiments, the machine-learning module 206 receives periodic observations after each window is complete (e.g., every 30 seconds). The machine-learning module 206 generates vector representations of the periodic observations in embedding space.

In some embodiments, the machine-learning module 206 generates, by using the machine-learning model, a vector database of abusive behavior embeddings and a vector database of benign behavior embeddings, where each database is associated with a vector index. For example, the machine-learning module 206 may use an inverted file indexing technique using k-means clustering to structure the abusive behavior embeddings and benign behavior embeddings into clusters within their respective vector databases. This analysis relates primarily to vector database indexing techniques rather than pre-calculating semantic clusters for direct classification. Other indexing techniques are possible, such as the use of an open-source vector database. In some embodiments, indexes for the vector databases are updated periodically (e.g., hourly, daily, weekly, etc.) with new examples of abusive behavior embeddings and benign behavior embeddings, respectively. In some embodiments, the abusive behavior embeddings and the benign behavior embeddings are stored in separate databases in the storage device 247.

In some embodiments, the machine-learning module 206 uses offline analysis of the embedding space to facilitate efficient searching of the vector database. This clustering organizes the data for faster lookup, allowing the search engine 208 to efficiently find the k-nearest neighbors (k-NN) for a new incoming embedding (i.e., a vector representation of periodic observations) during the similarity search phase, rather than assigning the incoming embedding to a predefined cluster label.

The search engine 208 generates a similarity score for each of the vector representations that reflects a similarity of a respective vector representation to at least one abusive behavior embedding and a similarity of the respective vector representation to at least one benign behavior embedding. In some embodiments, the search engine 208 generates the similarity score by classifying the respective vector representation based on a k-nearest neighbors algorithm. In some embodiments, k=5, but other values may also be used.

In some embodiments, the search engine 208 determines a similarity between a vector representation and the k-nearest neighbors in the database of abusive behavior embeddings (\tilde{x}ᵢ) and a similarity between the vector representation and the k-nearest neighbors in the database of benign behavior embeddings (\tilde{x}ⱼ) using contrastive learning. The contrastive learning approach identifies users who exhibit behavior that is similar to known harmful behavior as well as distinct from benign behavior, thereby reducing false positives.

For example, an embedding vector generated from a user's chat message is compared against the k-nearest embeddings in the abusive behavior vector database and the k-nearest embeddings in the benign behavior vector database. The similarity scores (e.g., cosine similarity) to the neighbors in each database are calculated and aggregated. A final score is generated based on comparing the aggregated similarity to abusive embeddings versus the aggregated similarity to benign embeddings. A high score indicates the user's behavior is significantly closer to known abusive examples than to benign ones.

In some embodiments, the search engine 208 includes a neural network base encoder that extracts representation vectors (hᵢ) and (hⱼ) from the similarities (\tilde{x}ᵢ) and (\tilde{x}ⱼ). For example, the following equation may be used:

hᵢ=f(\tilde{x}ᵢ)=BaseEncoderModel(\tilde{x}ᵢ) Eq. 1

where hᵢ∈ [symbol] ^{d} is an output after the average pooling layer.

The search engine 208 may include a neural network projection head (g(⋅)) that maps representations to a latent space where contrastive loss is applied. The search engine 208 may use a MultiLayer Perceptron (MLP) with one hidden layer to obtain a result using the following equation:

zᵢ=g(hᵢ)=W⁽²⁾σ(W⁽¹⁾hᵢ) Eq. 2

where σ is a ReLU non-linearity.

The search engine 208 determines the similarity score based on a contrastive loss function that is defined for a contrastive prediction task. Given a set ( [symbol] ) including a similarity of the top k-nearest neighbors for abusive behavior (\tilde{x}ᵢ) and a similarity of the top k-nearest neighbors for benign behavior (\tilde{x}ⱼ), the contrastive prediction task aims to identify \tilde{x}ⱼ in { [symbol] }_{k≠i} for a given \tilde{x}ᵢ. In some embodiments, the similarity score is an adaptation of a loss function commonly used in contrastive learning frameworks and is defined using the following equation:

$$similarity score = - log \frac{exp ( sim ( {z}_{i} , {z}_{j} ) / τ )}{{Σ}_{l = 1}^{{k}_{[ l \neq i ]}} exp ( sim ( {z}_{i} , {z}_{j} ) / τ )} \qquad Eq . 3$$

where zᵢ and zⱼ are derived from aggregated k-nearest neighbor similarities to abusive behavior embeddings and benign behavior embeddings, the denominator is a sum for l from 1 to k for all l where l is not equal to i, and τ denotes a temperature parameter.

In some embodiments, the search engine 208 calculates the similarity score by calculating a first exponent of an aggregation of the similarity of the respective vector representation to a predetermined number of abusive behavior embeddings (e.g., using the k-nearest neighbors), calculates a second exponent of an aggregation of the similarity of the respective vector representation to a predetermined number of benign behavior embeddings (e.g., using the k-nearest neighbors), and divides the first exponent by the second exponent. This formula may be used when the configuration prioritizes the contrastive aspect over likelihood estimation. In some embodiments, the search engine 208 divides the first exponent by a sum of the first exponent and the second exponent. This formula normalizes the score, typically to a [0, 1] range. The choice between these formulas is a configuration setting based on empirical performance and desired score properties.

In some embodiments, the search engine 208 uses a mean of the exponentiated similarities between a vector representation and the k-nearest neighbors in the database of abusive behavior embeddings and a mean of the exponentiated similarities between the vector representation and the k-nearest neighbors in the database of benign behavior embeddings. Using the mean aggregation (instead of sum or max) provides stability against variations in the density of the vector space and the number of neighbors found. Using a mean of k neighbors is also an improvement on using a maximum similarity from a single nearest neighbor to avoid being affected too much by spurious similarities, which might arise due to effects like vector space “folding” where incorrect language detection or model limitations cause unrelated embeddings to appear artificially close. “Folding” here refers to potential aliasing or collisions in the embedding space where, for instance, a misclassified language input produces an embedding that incorrectly maps near embeddings of a different language or meaning.

In some embodiments, if the similarity score is below a predetermined configurable threshold value (e.g., 0.1), the search engine 208 replaces the similarity score with 0 to filter out low-confidence scores where the similarity to positive examples is not significantly higher than to negative examples.

The risk scoring engine 210 generates a risk score based on aggregating the similarity scores and a user history. In some embodiments, the risk scoring engine 210 aggregates the similarity scores for activity that occurs in a 24-hour time period along with user history that includes a longer context than the 24-hour time period.

The user history includes other user behaviors that may be relevant for assessing a risk that the user is committing abuse. For example, the user history may include an abuse report submitted by a user in the virtual environment, an incident reviewed by a moderator, and/or a clothing item designed for an avatar associated with the user account that is abusive. Other examples of user history may include records of previous enforcement actions (warnings, suspensions, bans), outputs from other detection systems or heuristics, account characteristics (e.g., account age, verification status), system-generated historical scores, and explicit feedback or labels applied by moderators in previous investigations.

In some embodiments, the risk scoring engine 210 uses a skewness of the similarity scores where the equation is:

$$skewness = \frac{mean - median}{standard deviation} \qquad Eq . 4$$

The skewness reduces the effect of a number of samples in a distribution so that highly active users are not punished for being active. The skewness advantageously prevents a situation where the risk score is higher for users with a greater number of user activities despite the users not engaging in abusive behavior. For example, if the range of risk scores is from 0 to 1.0, where 1.0 is the highest value associated with abuse, if each similarity score for a periodic observation is 0.05, it takes 20 periodic observations to achieve the highest value. Conversely, if the risk score incorporates skewness, similarity scores that are mostly low result in a low-risk score, but a user that is dedicated to abuse will be associated with high similarity scores that skew towards a resulting high-risk score.

In some embodiments, the risk scoring engine 210 generates types of risk scores for different types of abuse. For example, the types of abuse may include child grooming, real-life threats, terrorism, violent extremism, self-harm, bullying and harassment, real-world dangerous activities, discrimination and hate, extortion and blackmail, sexual content, violent content and gore, threats of violence, illegal activities, misleading impersonation or misrepresentation, solicitation of personally identifiable information, etc. In some embodiments, the types of risk scores are generated based on applying a classifier to a longer portion of the user activity (e.g., a day of user activity, a week of user activity, etc.) that is trained to identify the specific type of abuse. For example, the risk scoring engine 210 may generate a terrorism risk score by applying a classifier that is trained to identify terrorism in the user activity.

The remedial action module 212 performs a remedial action based on the risk score and/or a type of risk score. The remedial actions are divided based on whether the risk score meets a first threshold value or a second threshold value. In some embodiments, if the risk score meets the first threshold value the remedial action includes providing a warning to the user; preventing the user from providing at least one of text, audio, and images; suspending the user account for a predetermined period of time, and/or banning the user account.

In some embodiments, the remedial action module 212 provides a warning to the user, suspends the user account for a predetermined period of time, or bans the user account is based on the risk score and the user history. For example, if the risk score ranges from 0 to 1.0 and the risk score is a 0.65, but the user has no user history of previous violations, the remedial action module 212 may provide a warning to the user. If the risk score is 0.65 and the user has a previous violation, the remedial action module 212 may suspend the user account for the predetermined period of time. In some embodiments, the predetermined period of time is based on the number of violations. For example, if the user has one previous violation, the suspension may be for two hours. If the user has two previous violations, the suspension may be for two days. In some embodiments, if the risk score is 0.8 or higher, the remedial action module 212 may ban the user account regardless of the user history. Other ranges, values, and thresholds may be used.

In some embodiments, the remedial action may be based on the different types of risk scores. For example, if the remedial action module 212 determines that a user committed multiple types of abuse within 24 hours after the user was previously muted or suspended for two days, the remedial action module 212 may permanently ban the user account.

In some embodiments, the remedial action module 212 applies different sets of rules based on an age of the user. In some embodiments, the rules are different for the following groups: 16-18 or over 18 years old. For example, if a user is 18 or over, the consequences for the user committing abuse may escalate faster than if the user was a minor. Other age groupings, and other demographic factors (e.g., gender, sexual orientation, location, participation history on the platform, etc.) may be used additionally or alternatively.

The remedial action module 212 may provide a series of warnings. For example, within a particular time window, such as a two-hour window, the remedial action module 212 may provide up to four warnings with at least a one-minute cool down period between warnings. In some embodiments, the remedial action module 212 may instruct the user interface module 202 to generate a first type of warning that takes up a small portion of the screen for the first two instances and a second type of warning that takes up a large part of the screen and requires an affirmative response from the first user for the third and fourth instances.

In some embodiments, the risk score is associated with a confidence value. The remedial action module 212 may determine a remedial action based on the confidence value. For example, the remedial action module 212 may not ban a user account if the confidence value is below a threshold confidence value of 60%.

In some embodiments, the remedial action module 212 determines if the risk score meets a second threshold value that is less than the first threshold value. If the risk score meets a second threshold value, the remedial action module 212 provides a portion of the user activity, along with significant related context, to a moderator for review via a review ticket or interface. The information provided to the moderator includes the specific activity or signal that triggered the review, but also extensive surrounding context such as communication logs involving the flagged user potentially spanning several weeks, information about the user (account details, age group), information about other involved users, and potentially machine-learning-generated highlights pointing to specific snippets of concern within the logs to aid review efficiency. Relevant user history summaries may also be included.

In some embodiments, the risk score is a ranking and a request for the moderator is placed in a queue with other requests for the moderator to review. In some embodiments, the higher the risk score the higher the ranking the request is placed in the queue.

The moderator reviews the user activity and provides feedback. The feedback includes modifying the risk score (e.g., increasing or decreasing the risk score), recommending that the user be monitored at one or more points in the future, taking no action, applying direct enforcement actions (e.g., warnings, suspensions, bans), or escalating the case to specialized teams. A critical action, particularly for severe harms, may include filing reports with external entities, such as law enforcement or child protection agencies (e.g., National Center for Missing & Exploited Children). If the feedback includes increasing the risk score so that it meets the first threshold, the remedial action module 212 may perform a remedial action associated with the first threshold.

In some embodiments, the search engine 208 receives the results of the feedback. In some embodiments, the search engine 208 updates the contrastive learning methodology based on the feedback. For example, the feedback may serve as ground truth labels for a loss function that identifies a difference between the similarity score output by the search engine 208 and the similarity score determined by a moderator. The feedback is also used to refine the positive and negative example databases or retrain the embedding models or the similarity scoring components.

In some embodiments, the risk scoring engine 210 receives the results of the feedback and updates the methodology for calculating the risk score based on the feedback. For example, the feedback may serve as ground truth labels for a loss function that identifies a difference between the risk score output by the risk scoring engine 210 and the risk score determined by a moderator. This may be used for retraining the risk scoring models or refining the features and aggregation logic used to calculate the risk score.

### Architecture

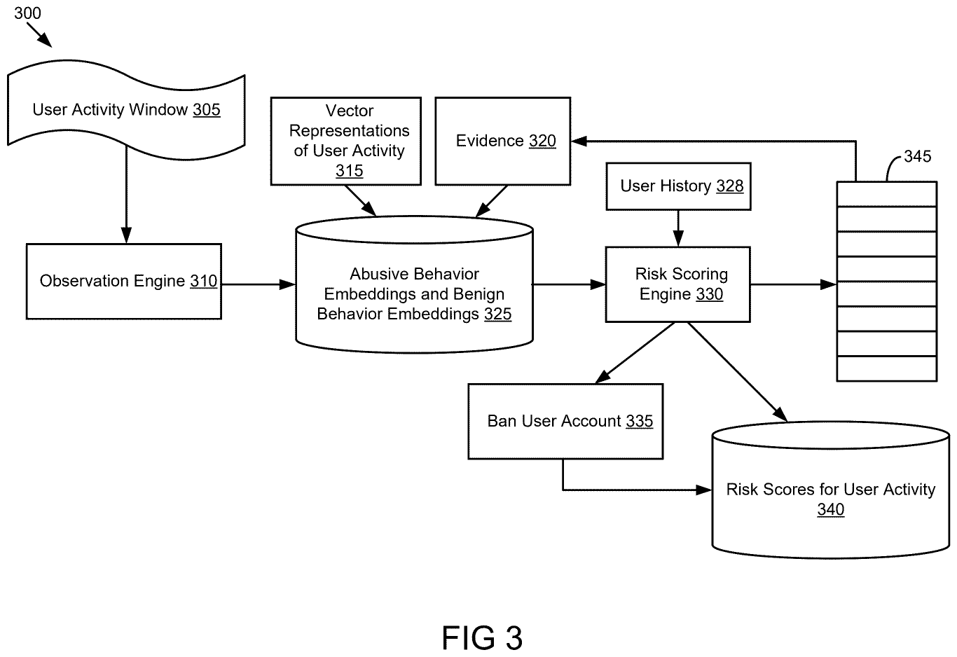

FIG. 3 is a block diagram of an example architecture 300 of the moderation application, according to some embodiments described herein. User activities 305 that are bounded by a window are received by an observation engine 310 that packages the user activities 305 as a periodic observation. The window may be a sliding window where user activities are within a range between two time periods. The observation engine 310 works with a machine-learning model (not shown) to convert the periodic observations into vector representations of user activity 315.

The vector representations of user activity 315 are compared to abusive behavior embedding and benign behavior embedding databases 325. The abusive behavior embedding and benign behavior embedding databases 325 are generated from the machine-learning model and supplemented with specific user activity content identified by moderators as evidence for determinations 320, which is discussed in greater detail below.

The feature store of abusive behavior embeddings and benign behavior embeddings 325 is used to compare the vector representations of user activity 315 to the abusive behavior embeddings and the benign behavior embeddings. The comparison results in a similarity score for each vector representation of user activity 315.

The risk scoring engine 330 receives the similarity scores and user history 328 and generates a risk score that aggregates the similarity scores. In some embodiments, the risk scoring engine 330 generates a risk score for a user every day and saves the risk scores in the risk scores for user activity database 340. If the risk score meets a first threshold, a user account associated with the user is banned. Information about banning the user account 335 is recorded in a user history database (e.g., the risk scores for user activity 340), which is used by the risk scoring engine 330 in generating future risk scores for the user account. If the risk score meets a second threshold, a request to review a portion of the user activity is stored in a queue 345 for moderator review. The risk score is ranked such that higher risk scores are ranked higher than lower risks scores so that the moderator reviews the higher risk scores before the lower risk scores.

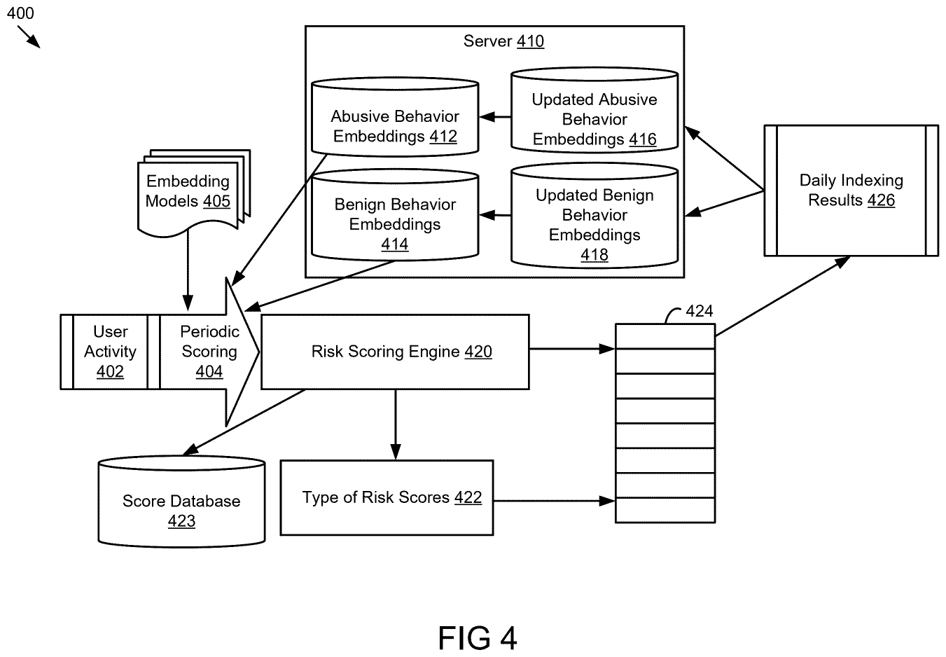

FIG. 4 is a block diagram of an additional example architecture 400 of the moderation application, according to some embodiments described herein. User activities that are bounded by a window 402 are periodically scores 404 to generate similarity scores. The periodic scoring 404 is based on converting the user activity 402 to respective vector representations using the machine-learning models 405. The machine-learning models 405 may include machine-learning models for different languages (e.g., an English machine-learning model, a language agnostic machine-learning model, etc.) and machine-learning models for different types of user activities (e.g., text, audio, and images).

The vector representations are compared to a database of abusive embeddings 412 and a database of benign behavior embeddings 414 that are stored on a separate server 410 from the machine-learning models 405. The database of abusive embeddings 412 and the database of benign behavior embeddings 414 are based on the machine-learning models 405 but stored on the server 410 to enable the database of abusive embeddings 412 and the database of benign behavior embeddings 414 to be retrained with the updated abusive behavior embeddings 406 and the updated benign behavior embeddings 418 on a daily or hourly basis.

The similarity scores are received by the risk scoring engine 420, which aggregates the similarity scores and generates a risk score based on the aggregated similarity scores and a user history. The similarity scores and the risk scores are stored in a score database 423. The risk scoring engine 420 performs batch querying of the similarity scores that are stored in the score database 423 for specific time periods to generate risk scores (e.g., hourly risk scores, daily risk scores, etc.).

In some embodiments, specific types of risk scores 422 are generated. For example, the types of risk scores 422 may include scores for users related to child grooming, real-life threats, terrorism, violent extremism, self-harm, bullying and harassment, real-world dangerous activities, discrimination and hate, extortion and blackmail, sexual content, violent content and gore, threats of violence, illegal activities, misleading impersonation or misrepresentation, solicitation of personally identifiable information, etc.

If the risk scores meet a threshold value specific to the types of risk scores 422, a request to review a portion of the user activity is stored in a queue 424 for moderator review. If the risk scores do not meet the threshold value, other actions may be performed, such as limiting a user's ability to friend other users for a predetermined period of time. The outcomes of the moderator review are incorporated into daily indexing results 426 and stored as updated abusive behavior embeddings 416 and updated benign behavior embeddings 418. The updated abusive behavior embeddings 416 are received by the database of abusive embeddings 412 periodically (e.g., once per day) and the updated benign behavior embeddings 418 are received by the database of benign behavior embeddings 414 periodically.

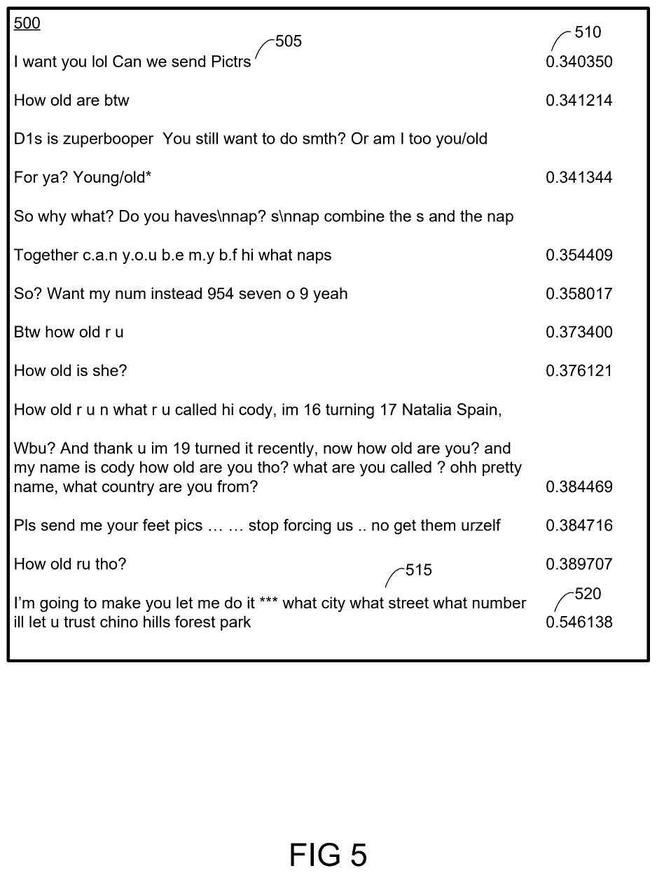

FIG. 5 is an example 500 of similarity scores for text chat, according to some embodiments described herein. The example 500 includes example text 505 and corresponding similarity scores 510. The similarity scores 510 increase as the example text 505 includes more abuse. For example, asking for pictures 505 has a similarity score of 0.340350 as compared to sexual talk (with one of the words replaced with ***) and requests for personally identifiable information being associated with a similarity score of 0.546138.

### User Interface

As explained above, the remedial action may include several forms and may be based on a severity of the risk score and user history (e.g., whether the first user is associated with previous remedial actions). In some embodiments, the remedial action module 212 enacts a temporary ban for initial violations and permanent bans for more severe violations and/or repeat violations. The ban may be an audio ban that prevents the first user from accessing their audio, while still being allowed to participate in a virtual experience, or a player ban that prevents the first user from engaging with the virtual experience for a period of time. For example, the player ban may include disabling login credentials.

In some embodiments, the first time that a first user experiences a remedial action, the remedial action module 212 may impose a first temporary ban (e.g., a one-day ban). The second time that the first user experiences a remedial action, the remedial action module 212 may impose a second temporary ban, where the second temporary ban is longer than the first temporary ban (e.g., a three-day ban). The third time that the first user experiences a remedial action, the remedial action module 212 may impose a permanent ban. In some embodiments, the permanent ban is permanent in that the length of the ban is indeterminant, although the permanent ban may be lifted by the remedial action module 212 based on other factors (e.g., responsive to the first user successfully appealing the permanent ban).

In some embodiments, after imposing a remedial action, the user interface module 202 generates graphical data for displaying a user interface that includes an explanation of the abuse that resulted in the remedial action.

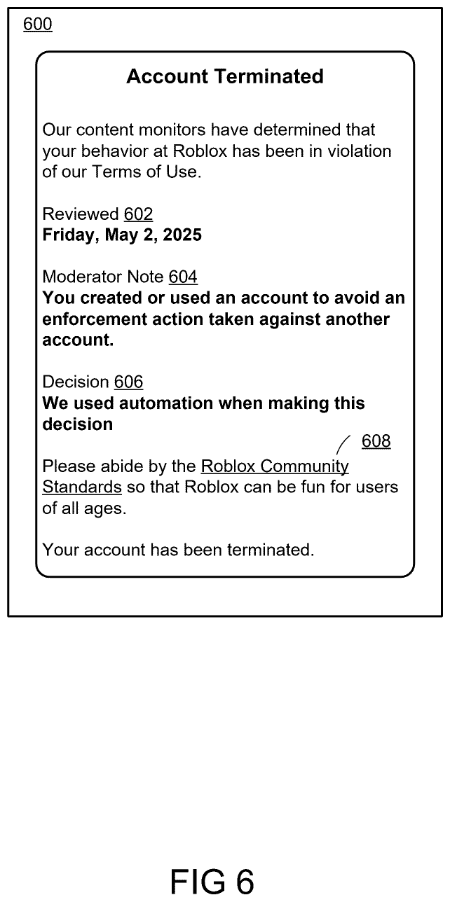

FIG. 6 illustrates an example user interface 600 of a remedial action, according to some embodiments described herein. In this example, the remedial action is a notification that the user's account has been terminated. The notification includes a date that the user activity was reviewed 602 (“Friday, May 2, 2025”), a moderator note 604 (“You created or used an account to avoid an enforcement action taken against another account”), a decision 606 (“We used automation when making this decision”), and a link 608 to Roblox Community standards.

### Method

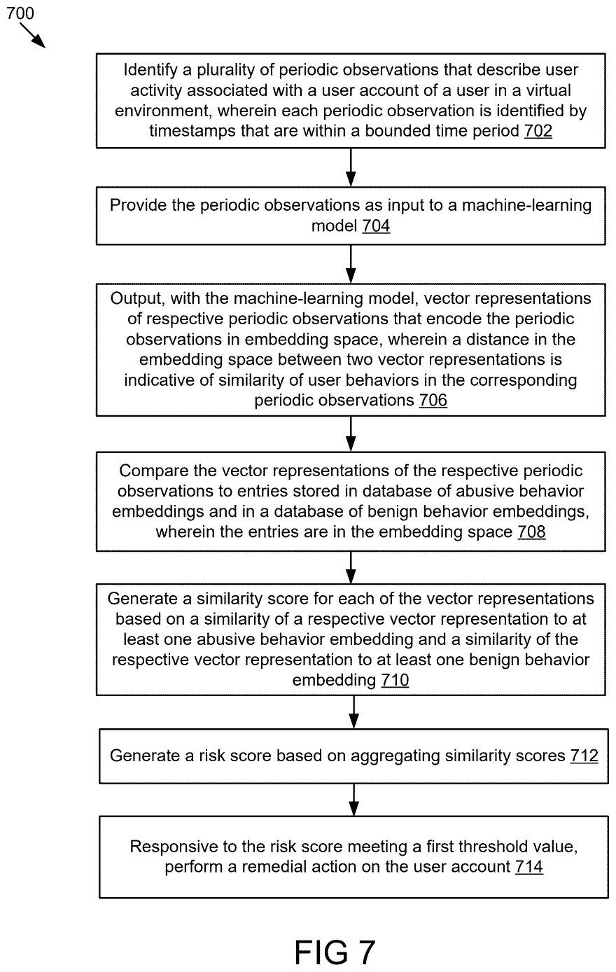

FIG. 7 is a flowchart of an example method 700 to moderate user activity, according to some embodiments described herein. The method 700 may be performed by moderation application 130 in FIG. 1 and/or the computing device 200 in FIG. 2.

The method 700 may start with block 702. At block 702, a plurality of periodic observations that describe user activity associated with a user account of a user of a virtual environment platform are identified. Each periodic observation is associated with timestamps that are within a bounded time period. Block 702 may be followed by block 704.

At block 704, the periodic observations are provided as input to a machine-learning model. In some embodiments, the machine-learning model is a multimodal machine-learning model and the periodic observations that describe the user activity include one or more of: text from the user account, audio from the user account, one or more images of an avatar associated with the user account, one or more images associated with the user account, and any combination thereof. Block 704 may be followed by block 706.

At block 706, the machine-learning model outputs vector representations of respective periodic observations that encode the periodic observations in embedding space, where a distance in the embedding space between two vector representations is indicative of similarity of user behaviors in the corresponding periodic observations. Block 706 may be followed by block 708.

At block 708, the vector representations of the respective periodic observations are compared to entries stored in database of abusive behavior embeddings and in a database of benign behavior embeddings, wherein the entries are in the embedding space. Block 708 may be followed by block 710.

At block 710, a similarity score is generated for each of the vector representations based on a similarity of a respective vector representation to at least one abusive behavior embedding and a similarity of the respective vector representation to at least one benign behavior embedding. Generating the similarity score may be based on the similarity of the respective vector representation to the at least one abusive behavior embedding and the at least one benign behavior embedding includes classifying the respective vector representation using a k-nearest neighbors algorithm. In some embodiments, the similarity score is generated based on contrastive learning by calculating a first exponent of an aggregation of the similarity of the respective vector representation to a predetermined number of abusive behavior embeddings; calculating a second exponent of an aggregation of the similarity of the respective vector representation to a predetermined number of benign behavior embeddings; and dividing the first exponent by the second exponent or dividing the first exponent by a sum of the first exponent and the second exponent. Block 710 may be followed by block 712.

At block 712, a risk score is generated based on aggregating similarity scores. In some embodiments, the risk score is also based on user history. In some embodiments, the risk score is based on a skewness of the similarity scores to reduce an effect of a number of the similarity scores in a distribution. In some embodiments, the skewness is calculated by determining a difference between a mean of the similarity scores from a median of the similarity scores and dividing the difference by a standard deviation of the similarity scores. Block 712 may be followed by block 714.

At block 714, responsive to the risk score meeting a first threshold value, a remedial action is performed on the user account. If the risk score meets the first threshold value, the remedial action may include providing a warning to the user; preventing the user from submitting at least one of text, audio, and images on the virtual environment platform; suspending the user account for a predetermined period of time; and/or banning the user account.

In some embodiments, responsive to the risk score meeting a second threshold value, the method 700 further includes providing a request to a moderator to review a portion of the user activity, wherein the second threshold value is lower than the first threshold value. Responsive to the moderator reviewing the portion of the user activity, the method 700 further includes providing feedback from the moderator to a user history associated with the user account, wherein the risk score is further based on the user history. In some embodiments, providing the request to the moderator to review the portion of the user activity includes adding the request to a queue for the moderator to review and the queue is sorted based on the risk score.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various embodiments. In some embodiments, blocks and operations can be performed multiple times, in a different order, and/or at different times in the methods.

Various embodiments described herein include obtaining data from various sensors in a physical environment, analyzing such data, generating recommendations, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., client device 110 only; client+server device; etc.) and where the data analysis is performed (e.g., client device 110 only; client+server device; etc.). Data is utilized for the specific purposes as described herein. No data is shared with third parties without express user permission.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one embodiments of the description. The appearances of the segment “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. A n algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, C D-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
identifying a plurality of periodic observations that describe user activity associated with a user account of a user of a virtual environment platform, wherein each periodic observation is associated with timestamps that are within a bounded time period;
providing the periodic observations as input to a machine-learning model;
outputting, with the machine-learning model, vector representations of respective periodic observations that encode the periodic observations in embedding space, wherein a distance in the embedding space between two vector representations is indicative of similarity of user behaviors in the corresponding periodic observations;
comparing the vector representations of the respective periodic observations to entries stored in database of abusive behavior embeddings and in a database of benign behavior embeddings, wherein the entries are in the embedding space;
generating a similarity score for each of the vector representations based on a similarity of a respective vector representation to at least one abusive behavior embedding and a similarity of the respective vector representation to at least one benign behavior embedding;
generating a risk score for the user account based on aggregating similarity scores; and
responsive to determining that the risk score meets a first threshold value, performing a remedial action on the user account.

2. The method of claim 1, wherein:
the machine-learning model is a multimodal machine-learning model; and
the periodic observations that describe the user activity include one or more of: text from the user account, audio from the user account, one or more images of an avatar associated with the user account, one or more images associated with the user account, and any combination thereof.

3. The method of claim 1, wherein generating the similarity score based on the similarity of the respective vector representation to the at least one abusive behavior embedding and the at least one benign behavior embedding includes classifying the respective vector representation using a k-nearest neighbors algorithm.

4. The method of claim 1, wherein the similarity score is generated based on contrastive learning by:
calculating a first exponent of an aggregation of the similarity of the respective vector representation to a predetermined number of abusive behavior embeddings;
calculating a second exponent of an aggregation of the similarity of the respective vector representation to a predetermined number of benign behavior embeddings; and
dividing the first exponent by the second exponent or dividing the first exponent by a sum of the first exponent and the second exponent.

5. The method of claim 1, further comprising:
responsive to the risk score meeting a second threshold value, providing a request to a moderator to review a portion of the user activity, wherein the second threshold value is lower than the first threshold value; and
responsive to the moderator reviewing the portion of the user activity, providing feedback from the moderator to a user history associated with the user account, wherein the risk score is further based on the user history.

6. The method of claim 5, wherein:
providing the request to the moderator to review the portion of the user activity includes adding the request to a queue for the moderator to review; and
the queue is sorted based on the risk score.

7. The method of claim 1, wherein responsive to the risk score meeting the first threshold, the remedial action is selected from a group of providing a warning to the user; preventing the user from submitting at least one of text, audio, and images on the virtual environment platform; suspending the user account for a predetermined period of time; banning the user account, or combinations thereof.

8. The method of claim 1, wherein the abusive behavior embeddings correspond to abusive behavior that are identified as abusive by one or more moderators and the benign behavior embeddings correspond to benign behavior that are identified by excluding abusive behavior from a corpus of prior user activity.

9. The method of claim 1, wherein the risk score is based on a skewness of the similarity scores to reduce an effect of a number of the similarity scores in a distribution.

10. The method of claim 9, further comprising calculating the skewness by determining a difference between a mean of the similarity scores from a median of the similarity scores and dividing the difference by a standard deviation of the similarity scores.

11. A system comprising:
one or more processors; and
a memory coupled to the one or more processors, with instructions stored thereon that, when executed by the one or more processors, cause the one or more processors to perform operations comprising:
identifying a plurality of periodic observations that describe user activity associated with a user account of a user of a virtual environment platform, wherein each periodic observation is associated with timestamps that are within a bounded time period;
providing the periodic observations as input to a machine-learning model;
outputting, with the machine-learning model, vector representations of respective periodic observations that encode the periodic observations in embedding space, wherein a distance in the embedding space between two vector representations is indicative of similarity of user behaviors in the corresponding periodic observations;
comparing the vector representations of the respective periodic observations to entries stored in database of abusive behavior embeddings and in a database of benign behavior embeddings, wherein the entries are in the embedding space;
generating a similarity score for each of the vector representations based on a similarity of a respective vector representation to at least one abusive behavior embedding and a similarity of the respective vector representation to at least one benign behavior embedding;
generating a risk score for the user account based on aggregating similarity scores; and
responsive to determining that the risk score meets a first threshold value, performing a remedial action on the user account.

12. The system of claim 11, wherein:
the machine-learning model is a multimodal machine-learning model; and
the periodic observations that describe the user activity include one or more of: text from the user account, audio from the user account, one or more images of an avatar associated with the user account, one or more images associated with the user account, and any combination thereof.

13. The system of claim 11, wherein generating the similarity score based on the similarity of the respective vector representation to the at least one abusive behavior embedding and the at least one benign behavior embedding includes classifying the respective vector representation using a k-nearest neighbors algorithm.

14. The system of claim 11, wherein the similarity score is generated based on contrastive learning by:
calculating a first exponent of an aggregation of the similarity of the respective vector representation to a predetermined number of abusive behavior embeddings;
calculating a second exponent of an aggregation of the similarity of the respective vector representation to a predetermined number of benign behavior embeddings; and
dividing the first exponent by the second exponent or dividing the first exponent by a sum of the first exponent and the second exponent.

15. The system of claim 11, wherein the operations further include:
responsive to the risk score meeting a second threshold value, providing a request to a moderator to review a portion of the user activity, wherein the second threshold value is lower than the first threshold value; and
responsive to the moderator reviewing the portion of the user activity, providing feedback from the moderator to a user history associated with the user account, wherein the risk score is further based on the user history.

16. A non-transitory computer-readable medium with instructions stored thereon that, when executed by one or more computers, cause the one or more computers to perform operations, the operations comprising:
identifying a plurality of periodic observations that describe user activity associated with a user account of a user of a virtual environment platform, wherein each periodic observation is associated with timestamps that are within a bounded time period;
providing the periodic observations as input to a machine-learning model;
outputting, with the machine-learning model, vector representations of respective periodic observations that encode the periodic observations in embedding space, wherein a distance in the embedding space between two vector representations is indicative of similarity of user behaviors in the corresponding periodic observations;
comparing the vector representations of the respective periodic observations to entries stored in database of abusive behavior embeddings and in a database of benign behavior embeddings, wherein the entries are in the embedding space;
generating a similarity score for each of the vector representations based on a similarity of a respective vector representation to at least one abusive behavior embedding and a similarity of the respective vector representation to at least one benign behavior embedding;
generating a risk score for the user account based on aggregating similarity scores; and
responsive to determining that the risk score meets a first threshold value, performing a remedial action on the user account.

17. The non-transitory computer-readable medium of claim 16, wherein:
the machine-learning model is a multimodal machine-learning model; and
the periodic observations that describe the user activity include one or more of: text from the user account, audio from the user account, one or more images of an avatar associated with the user account, one or more images associated with the user account, and any combination thereof.

18. The non-transitory computer-readable medium of claim 16, wherein generating the similarity score based on the similarity of the respective vector representation to the at least one abusive behavior embedding and the at least one benign behavior embedding includes classifying the respective vector representation using a k-nearest neighbors algorithm.

19. The non-transitory computer-readable medium of claim 16, wherein the similarity score is generated based on contrastive learning by:
calculating a first exponent of an aggregation of the similarity of the respective vector representation to a predetermined number of abusive behavior embeddings;
calculating a second exponent of an aggregation of the similarity of the respective vector representation to a predetermined number of benign behavior embeddings; and
dividing the first exponent by the second exponent or dividing the first exponent by a sum of the first exponent and the second exponent.

20. The non-transitory computer-readable medium of claim 16, wherein the operations further include:
responsive to the risk score meeting a second threshold value, providing a request to a moderator to review a portion of the user activity, wherein the second threshold value is lower than the first threshold value; and
responsive to the moderator reviewing the portion of the user activity, providing feedback from the moderator to a user history associated with the user account, wherein the risk score is further based on the user history.
